(19) United States
(12) Patent Application Publication
(10) Pub. No.: US 2003/0098425 A1
(43) Pub. Date: May 29, 2003

(54) Leak locating device using an ultraviolet LED

(76) Inventor: Peter Sosinsky, Mississauga (CA)

Correspondence Address: Stephen M. Beney, Bereskin & Parr, 40 King Street West, Box 401, Toronto, ON, M5H 3Y2, CA

(21) Appl. No.: 09/995,864

(22) Filed: Nov. 29, 2001

(51) Int. Cl. G01J 1/00

(52) U.S. Cl. 250/504 R

(57) ABSTRACT

The present invention provides a device that uses an ultraviolet LED to locate fluorescent materials. In particular, the present invention is directed to a device that is used to detect leaks, cracks or fissures in a contained system, such as, for example, an air conditioning system for a vehicle. The device has a main body, an ultraviolet LED mounted to the main body so that ultraviolet light from the LED is directed away from the device, and a power source linked to the ultraviolet LED to provide power to the LED. The ultraviolet LED can be an UVA LED. Moreover, the wavelength of the ultraviolet light produced by tho LED is about 315 nm to about 400 nm. The method of the invention for locating fluid leaks can comprise, for example, introducing an ultraviolet dye into a fluid in a contained system, such as, for example, an air conditioning system of a vehicle, and illuminating an area of the system to be checked for fluid leaks with an ultraviolet LED light source. The ultraviolet light from the LED causes the ultraviolet dye in the fluid to fluoresce.

### FIELD OF THE INVENTION

This invention relates to a device that uses an ultraviolet LED to locate fluorescent materials.

### BACKGROUND OF THE INVENTION

By adding an ultraviolet dye to a fluid a fluorescent material can be added to the fluid that is visible when an ultraviolet light is used to illuminate the fluid. The ultraviolet dye absorbs energy in the ultraviolet range and re-radiates, or fluoresces, the energy at a longer wavelength in the visible spectrum. A fluid containing such a fluorescent material can be used to detect leaks, cracks or fissures in a contained system.

### SUMMARY OF THE INVENTION

The present invention provides a device that uses an ultraviolet LED to locate fluorescent materials. In particular, the present invention is directed to a device that is used to detect leaks, cracks or fissures in a contained fluid system, such as, for example, an air conditioning system for a vehicle. A method of the invention for locating fluid leaks can comprise, for example, introducing an ultraviolet dye into a fluid in the system, and illuminating an area of the system to be checked for fluid leaks with an ultraviolet LED light source. The ultraviolet light from the LED causes the ultraviolet dye in the fluid to fluoresce.

The device of the present invention comprises a main body, an ultraviolet LED mounted to the main body so that ultraviolet light from the LED is directed away from the device, and a power source linked to the ultraviolet LED to provide power to the LED.

The ultraviolet LED can be an UVA LED. In particular, the wavelength of the ultraviolet light produced by the LED is about 315 nm to about 400 nm. In one embodiment the LED comprises a plurality of LED lights mounted to a circuit board, and, in particular, three LED lights.

The power source of the device can be a battery source, and can be mounted in the main body of the device. An on/off switch can also be mounted to the main body. In one embodiment the main body of the device has two ends and a longitudinal axis, and the on/off switch is mounted to the main body at one of the ends thereof.

The device can further comprise a housing connected to the main body. In one embodiment the ultraviolet LED is mounted to the housing. The housing can be connected to the main body at one of its ends opposite to where the on/off switch is mounted.

Further an extension can be provided to connect the housing to the main body. The extension can be flexible to facilitate the use of the LED of the device in a variety of tight spaces when inspecting the contained system.

### BRIEF DESCRIPTION OF THE DRAWINGS

For a better understanding of the present invention and to show more clearly how it would be carried into affect, reference will now be made, by way of example, to the accompanying drawings that show various embodiments of the present invention, and in which.

FIG. 1 is an exploded perspective view one embodiment of the device of this invention;

FIG. 2 is a side cross-sectional view of the device of FIG. 1;

FIG. 3 is an exploded perspective view of an alternative embodiment of this invention;

FIG. 4 is a perspective view of a further alternative embodiment of this invention; and

FIG. 5 is a perspective view of this invention as being used to locate a leak in a motor vehicle engine.

### DETAILED DESCRIPTION OF THE INVENTION

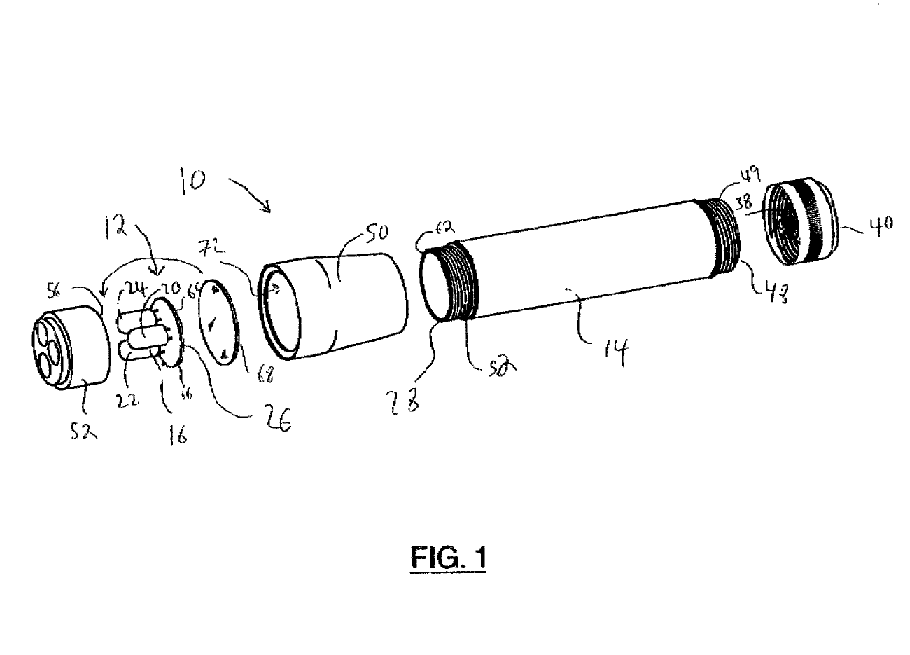

Referring to FIG. 1, a device 10 for locating fluorescent materials is disclosed in particular, device 10 of the present invention is used to detect fluorescent material in a fluid. By providing a fluorescent material, and particularly, an ultraviolet dye, in a fluid, the device 10 can be used to detect leaks, cracks or fissures in a contained fluid system, such as, for example, an air conditioning system for a vehicle. As will be described in greater detail below, the device 10 illuminates an area of the system to be checked for fluid leaks, cracks, or fissures with an ultraviolet LED light source 12. The ultraviolet light from the LED tight source 12 causes the ultraviolet dye in the fluid to fluoresce.

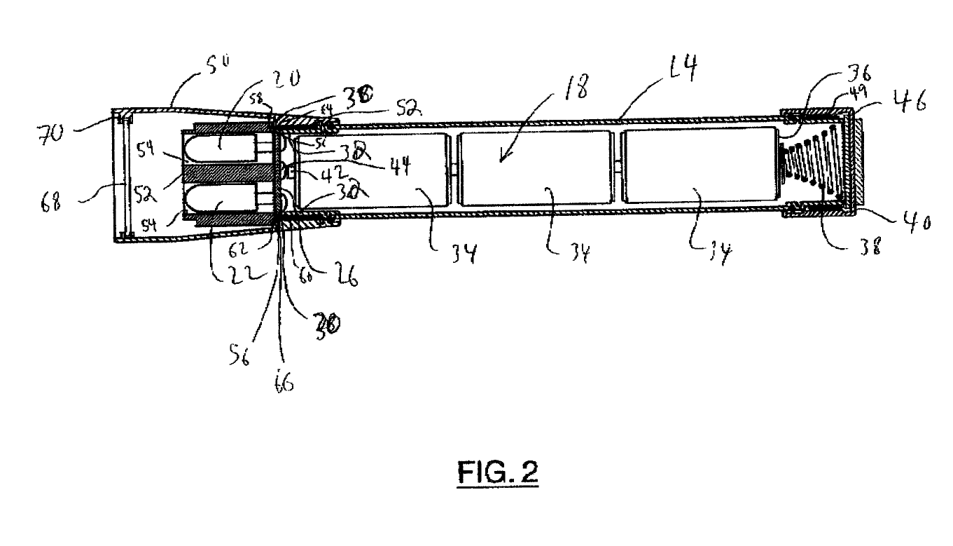

The device 10 comprises a main body 14. An ultraviolet LED assembly 16 is mounted to the main body 14 as will be described below. LED assembly 16 is mounted to the main body 14 so that ultraviolet light from the LED assembly 16 is directed away from the device 10. A power source 18 (see FIG. 2) is linked to the ultraviolet LED assembly 16, as will be described in greater detail below, to provide power to the LED assembly 16. In the embodiments illustrated the main body 14 of the device 10 is generally an elongate cylinder having two ends and a longitudinal axis. Moreover, for the embodiments illustrated, the generally elongate main body 14 can serve as a handle or an area for a user to grip the device 10.

The ultraviolet LED assembly 16 can be an UVA LED. In particular, the wavelength of the ultraviolet light produced by the LED assembly 16 is about 315 nm to about 400 nm. In the embodiment disclosed in FIG, , the LED assembly 16 comprises three LED lights 20, 22, and 24, mounted to a circuit board 26. The LED lights 20, 22, and 24 can be, for example, 5 mm UVA LED lights that are soldered to the circuit board 26. By using an ultraviolet LED as described, when an ultraviolet dye, such as, for example SHOOT'N SHINE™ as sold by J.L. Sales and Marketing, Inc. of Mississauga, Ontario, Canada, is added to a fluid, the ultraviolet dye absorbs energy in the ultraviolet range when illuminated by the LED assembly 16 and re-radiates, or fluoresces, the energy at a longer wavelength in the visible spectrum. Therefore a fluid containing such an ultraviolet dye can be used to detect leaks, cracks or fissures in a contained fluid system.

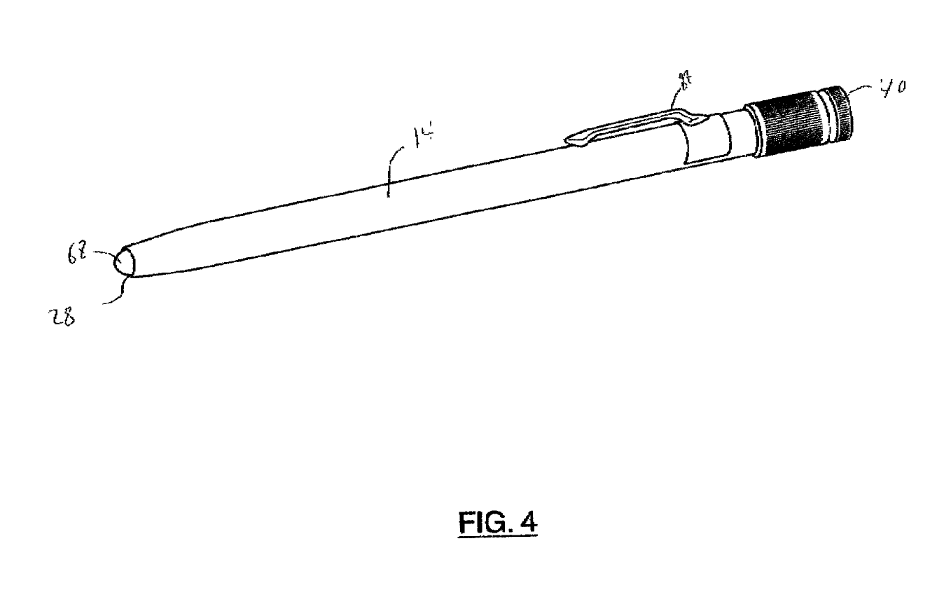

As illustrated in FIG. 2 the circuit board 26 is mounted on one end 28 of the main body 14 so that a portion of the circuit board 30 is in electrical contact with a portion 32 of the main body 14. For the embodiment disclosed the power source 18 of the device 10 is a battery source that is mounted in the cylindrical main body 14 of the device 10. For the embodiment of FIG. 1 the battery source is three N cell batteries 34 of 1.5 volts each. AA cell batteries of 1.5 volts each can also be used, as could AAAA batteries of 1.2 volts each (for example, the “penlight” of FIG. 4 could use AAAA batteries). In all instances one end 36 of at least one of the batteries 34 is in electrical contact with a spring contact 38 provided by an end cap 40 of the main body 14. The other end 42 of at least one of the batteries 34 is in electrical contact with a portion 44 of the circuit board 26. As is known to those skilled in the art, at least a portion of the main body 14, spring contact 38 and end cap 40, and the circuit board 26 are used to form a closed electrical loop with the battery power source to activate the ultraviolet LED assembly 16.

An on/off switch 46 is provided to close the circuit and activate the ultraviolet LED assembly 10. For the embodiment illustrated the on/off switch 46 is mounted to the main body 14 at end 48 thereof and is part of the end cap 40. For the illustrated embodiments me on/off switch is a momentary switch that rotates in one direction to complete the circuit and provide power to illuminate the LED assembly 16, and that rotates in an opposite direction to break the circuit, thereby disconnecting the power to the LED assembly 16.

The end cap 40 can be releasably connected to the main body to allow the battery source to be inserted and removed from the cavity of the cylindrical main body 14. For the embodiments illustrated the end cap is releasably secured to the main body 14 by a threaded connection 49 that is provided therebetween. The threaded connection also allows for rotation of the end cap 40 enabling operation of the momentary on/off switch 46.

To mount the LED assembly 16 to the main body 14 of the device and, particularly, to retain the circuit board 26 in appropriate electrical contact with the power source, a housing 50 an be provided. The housing 50 can be releasably connected to the main body 14 at end 28, and, for the embodiments illustrated, a threaded connection 52 is provided between the housing 50 and the main body 14.

To retain the LED assembly 16 in the housing 50 an LED support housing 52 can be provided. The LED support housing 52 has a number of cavities 54 that receive respective LED lights 20, 22, and 24, of the LED assembly 16 of the embodiment illustrated. The LED support housing 52 can protect the LED lights from damage should the device be subject to an outside force, such as being dropped, for example.

Moreover, LED support housing 52 provides a surface 56 against which a portion 58 of the circuit board 26 abuts. A surface 60 on the opposite side of the circuit board 26 abuts against an edge 62 provided by end 28 of the main body 14. This arrangement retains the circuit board 26 within housing 50 sandwiched between the LED support housing 52 and the main body 14. To ensure that the LED assembly 16 is axially aligned within housing 50, a ledge 64 can be provided by housing 50 against which the side edges 66 of the circuit board 26 can abut. In this manner the LED assembly 16 can be securely mounted within the housing 50 and to the main body 14. It can be appreciated that other arrangements can be utilized to provide a secure mounting of the LED assembly 16 to the main body 14 of the device 10.

A lens 68 can be provided in the housing 50. In the embodiment illustrated the lens 68 is retained in the housing 50 in a suitable groove 70 so that the lens 68 extends across the width of the opening 72 of the housing 50. The opening 72 and the lens 68 allow the ultraviolet light from the LED assembly 16 to be projected away from the device 10 and through the opening 72. In the embodiment disclosed, the lens 68 is clear.

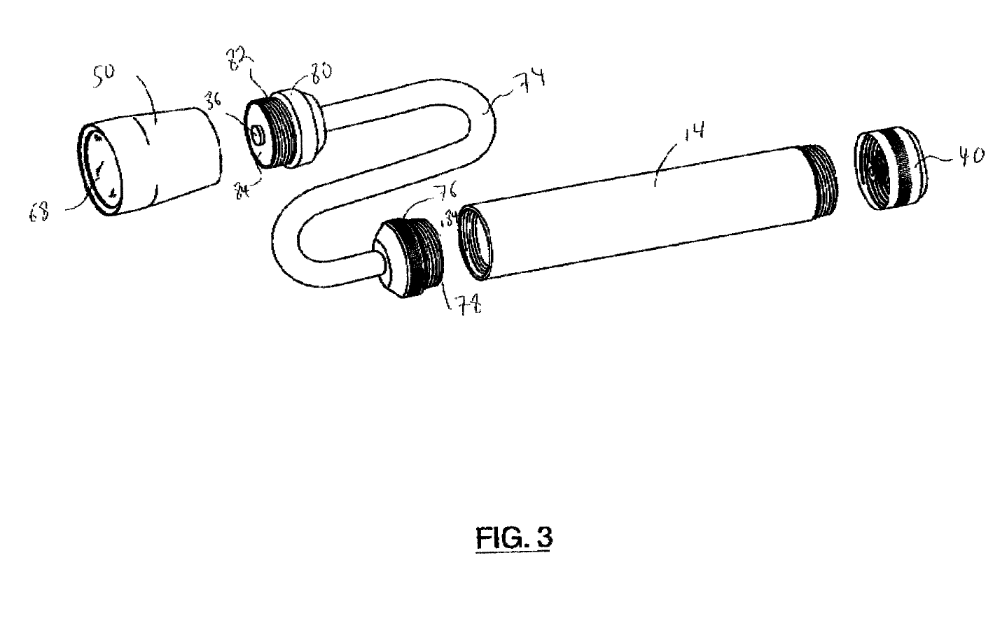

The device 10 of the embodiment illustrated in FIG. 3 is similar to the embodiment of FIG. 1, except that an extension 74 is provided between the housing 50 and the main body 14. The extension can be connected to the main body at one end 76 thereof using a threaded connection 78, and can be connected to the housing 50 at the other end 80 thereof using a threaded connection 82. The extension 74 can be flexible to facilitate the use of the LED assembly 16 that is housed in housing 50 of the device 10 in a variety of tight spaces when inspecting a contained system for fluid leaks. The extension 74 should also provide for a sufficient electrical link between the LED assembly 16 and the power source 18 in the main body 14. For example, the respective ends 84 of the extension 74 can be provided with respective portions 86 that provide electrical contact between the battery source 18 and the LED assembly 15. Flexible extension 74 should be able to retain the configuration that it is bent into, as is known to those skilled in the art.

FIG. 4 illustrates a further alternative embodiment of the invention that is similar to the embodiment illustrated in FIG. 1, except that LED assembly 16 has only one light. As a result the power source can be provided by 1.2-volt AAAA batteries. This results in the device being very compact, and of the order of the size of a typical penlight. For this embodiment a pocket clip 88 can be provided to secure the device 10 to a shirt pocket. The rest of the elements of the device 10 in this embodiment are otherwise similar to the elements described above for the embodiment illustrated in FIG. 1. For this embodiment there is no separate housing 50, and the LED assembly 16 is retained within one end 28 of the main body 14 of the device 10. The lens 68 can be shaped to fit over the one light of the LED assembly 18 which, for the embodiment illustrated, projects beyond end 28 of the main body 14.

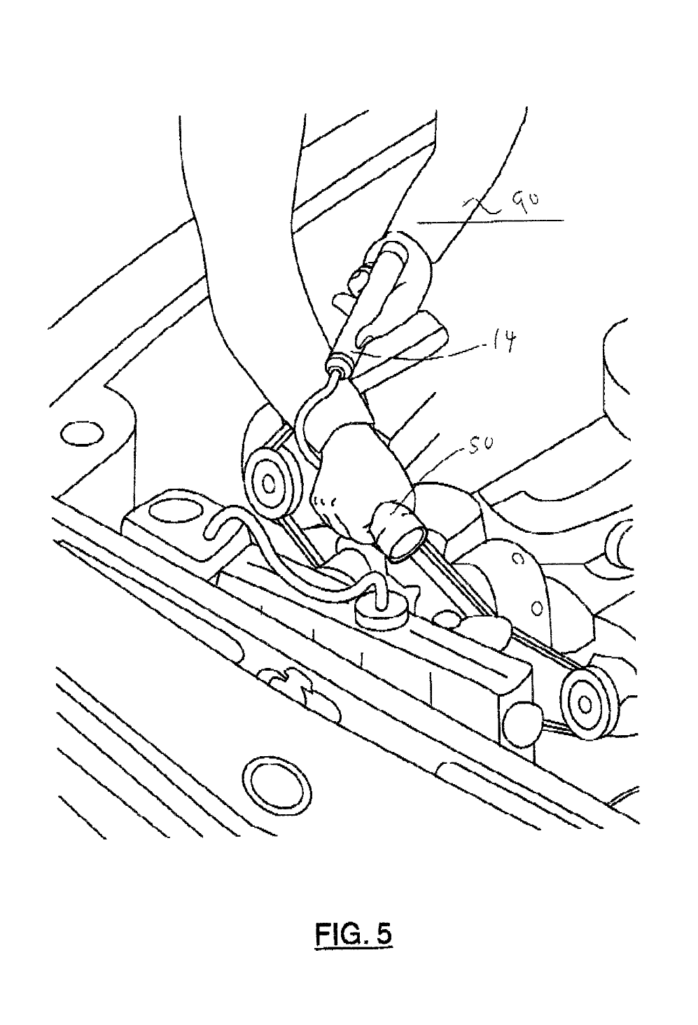

FIG. 5 shows an individual 90 using a device 10 to inspect a contained fluid system, such as, for example, an air conditioning system of a vehicle, for fluid leaks, cracks, and fissures. In the method of this invention a suitable ultraviolet dye, such as, for example, SHOOT'N SHINE™, as mentioned earlier, is introduced into a fluid in the system to be inspected. The external surface areas of the system holding the fluid to be inspected are illuminated with the ultraviolet LED light source of device 10. The ultraviolet dye in the fluid absorbs energy from the ultraviolet light and re-radiates, or fluoresces, the energy at a longer wavelength in the visible spectrum. Therefore, fluid containing such a fluorescent material that has leaked through a crack or fissure in the system can be located, which, in turn, can be used to locate the leaks, cracks or fissures in the contained system. The leaks, cracks or fissures can then be repaired or that portion of the system replaced as desired.

It can be appreciated that variations to this invention would be readily apparent to those skilled in the art, and this invention is intended to include those alternatives.

1. A device to locate fluorescent materials, comprising:
a) a main body;
b) an ultraviolet LED mounted to the main body so that ultraviolet light from the LED is directed away from the device; and
c) a power source linked to the ultraviolet LED to provide power thereto.

2. A device according to claim 1 wherein the ultraviolet LED is an UVA LED.

3. A device according to claim 1 wherein the wavelength of the ultraviolet light produced by the LED is about 315 nm to about 400 nm.

4. A device according to claim 1 wherein the LED comprises a plurality of LED lights mounted to a circuit board.

5. A device according to claim 4 wherein the number of LED lights is three.

6. A device according to claim 1 wherein the power source is a battery source.

7. A device according to claim 6 wherein the power source is mounted in the main body.

8. A device according to claim 7 further comprising an on/off switch mounted to the main body.

9. A device according to claim 1 further comprising a housing connected to the main body and wherein the ultraviolet LED is mounted to the housing.

10. A device according to claim 9 wherein the main body has two ends and a longitudinal axis.

11. A device according to claim 10 wherein the housing is connected to the main body at one end thereof.

12. A device according to claim 11 further comprising an on/off switch mounted to the main body at the other and thereof.

13. A device according to claim 11 wherein the housing is provided with a lens through which the light from the LED projects.

14. A device according to claim 11 further comprising an extension to connect the housing to the main body.

15. A device according to claim 14 wherein the extension is flexible.

16. A device according to claim 10 wherein the main body comprises a handle portion.

17. A method of locating fluid leaks, comprising;
a) introducing an ultraviolet dye into a fluid in a contained system; and
b) illuminating an area of the system to be checked for fluid leaks with an ultraviolet LED.

18. A method according to claim 17 wherein the ultraviolet LED is an UVA LED.

19. A method according to claim 17 wherein the wavelength of the ultraviolet light produced by the LED is about 315 nm to about 400 nm.

20. A method according to claim 17 wherein the LED is powered by a battery source that is mounted in a device that houses the LED.

21. The use of a device to locate fluid leaks, where the fluid contains an ultraviolet dye, the device comprising:
a) a main body;
b) an ultraviolet LED mounted to the main body so that ultraviolet light from the LED is directed away from the device; and
c) a power source linked to the ultraviolet LED to provide power thereto.

22. A use according to claim 21 wherein the ultraviolet LED of the device is an UVA LED.

23. A use according to claim 21 wherein the wavelength of the ultraviolet light produced by the LED of the device is about 315 nm to about 400 nm.

24. A use according to claim 21 wherein the power source of the device is a battery source.
